(19) United States
(12) Patent Application Publication
(10) Pub. No.: US 2010/0112360 A1
(43) Pub. Date: May 6, 2010

(54) LAYERED THERMAL INTERFACE SYSTEMS METHODS OF PRODUCTION AND USES THEREOF

(76) Inventor: Andrew D. Delano, Spokane Valley, WA (US)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/262,704

(22) Filed: Oct. 31, 2008

(51) Int. Cl. B32B 15/04; C23C 28/00

(52) U.S. Cl. 428/450; 205/183

(57) ABSTRACT

A layered thermal interface system is described herein that comprises: at least one deposition layer of metal, at least one layer of thermal interface material, at least one plated layer of metal, and at least one heat spreader. Another layered thermal interface system is described herein that comprises: a silicon layer, at least one deposition layer of metal, at least one layer of thermal interface material, at least one plated layer of metal, and at least one heat spreader Methods of forming contemplated layered thermal system comprise: a) providing at least one deposition layer of metal, b) providing at least one plated layer of metal, c) providing at least one thermal interface material, and d) layering the at least one deposition layer of metal, the at least one thermal interface material, and the at least one plated layer of metal to produce the layered thermal system. Methods of forming another contemplated layered thermal system comprise: a) providing a silicon die, layer or surface, b) providing at least one deposition layer of metal, c) providing at least one plated layer of metal, d) providing at least one thermal interface material, e) providing at least one heat spreader material, and f) layering the silicon surface, the at least one deposition layer of metal, the at least one thermal interface material, the at least one plated layer of metal and the at least one heat spreader to produce the layered thermal system.

### FIELD OF THE INVENTION

The field of the invention is layered systems that include thermal interface materials and systems in electronic components, semiconductor components and other related layered materials applications.

### BACKGROUND

Electronic components are used in ever increasing numbers of consumer and commercial electronic products. Examples of some of these consumer and commercial products are televisions, personal computers, Internet servers, cell phones, pagers, palm-type organizers, portable radios, car stereos, or remote controls. As the demand for these consumer and commercial electronics increases, there is also a demand for those same products to become smaller, more functional, and more portable for consumers and businesses.

As a result of the size decrease in these products, the components that comprise the products must also become smaller and better manufactured and designed. Examples of some of those components that need to be reduced in size or scaled down are printed circuit or wiring boards, resistors, wiring, keyboards, touch pads, and chip packaging. Many products and components also need to be prepackaged, such that the product and/or component can more readily be adapted to perform several related or unrelated functions and tasks. Examples of some of these “total solution” components and products comprise layered materials, mother boards, cellular and wireless phones and telecommunications devices and other components and products, such as those found in US Patent and PCT Application Ser. No. 60/396,294 filed Jul. 15, 2002, 60/294433 filed May 30, 2001 and PCT/US02/17331 filed May 30, 2002, which are all commonly owned and incorporated herein in their entirety.

Components, therefore, are being broken down and investigated to determine if there are better building materials and methods that will allow them to be scaled down and/or combined to accommodate the demands for smaller electronic components. In layered components, two goals appear to be a) decreasing the number of the layers and/or b) decreasing the thickness of the layers while at the same time increasing the functionality and durability of the remaining layers in both cases. This task can be difficult, however, given that the number of layers cannot readily be reduced or made thinner without sacrificing functionality.

Also, as electronic devices become smaller and operate at higher speeds, energy emitted in the form of heat flux increases dramatically. It has also been found that the performance of these materials deteriorates when large deviations from surface planarity causes gaps to form between the mating surfaces in the electronic devices, or when large gaps between mating surfaces are present for other reasons, such as manufacturing tolerances, etc. When the heat transferability of these materials breaks down, the performance of the electronic device in which they are used is adversely affected.

In the case of modern flip chip microprocessors, these processors require a thermal interface material that can minimize the resistance to heat flow from the backside of the die to the environment. Conventional flip chip microprocessors utilize indium solder for this purpose. In these cases, indium solder is utilized to create a metallurgical bond from the silicon surface to the heat spreader. In order to create this bond, the silicon surface must be coated with a thin layer of gold, along with a titanium barrier layer. The heat spreader is also coated with gold. In addition, a flux is used to “encourage” the indium solder to wet these metalized surfaces. This process is not only delicate and results in a large number of processing steps, but also leaves some voiding on both surfaces. The voiding impairs heat transfer and ultimately the reliability of the thermal joint or stack.

Thus, there is a continuing need to: a) design and produce thermal interconnects and thermal interface materials, layered materials, components and products that meet customer specifications while minimizing the size of the device and number of layers; b) produce more efficient and better designed materials, products and/or components with respect to the compatibility requirements of the material, component or finished product; c) develop reliable methods of producing desired thermal interconnect materials, thermal interface materials and layered materials and components/products comprising contemplated thermal interface and layered materials; and d) effectively reduce the number of production steps necessary for a package assembly, which in turn results in a lower cost of ownership over other conventional layered materials and processes.

### SUMMARY OF THE INVENTION

A layered thermal interface system is described herein that comprises: at least one deposition layer of metal, at least one layer of thermal interface material, at least one plated layer of metal, and at least one heat spreader.

Another layered thermal interface system is described herein that comprises: a silicon layer, at least one deposition layer of metal, at least one layer of thermal interface material, at least one plated layer of metal, and at least one heat spreader.

Methods of forming contemplated layered thermal system comprise: a) providing at least one deposition layer of metal, b) providing at least one plated layer of metal, c) providing at least one thermal interface material, and d) layering the at least one deposition layer of metal, the at least one thermal interface material, and the at least one plated layer of metal to produce the layered thermal system.

Methods of forming another contemplated layered thermal system comprise: a) providing a silicon die, layer or surface, b) providing at least one deposition layer of metal, c) providing at least one plated layer of metal, d) providing at least one thermal interface material, e) providing at least one heat spreader material, and f) layering the silicon surface, the at least one deposition layer of metal, the at least one thermal interface material, the at least one plated layer of metal and the at least one heat spreader to produce the layered thermal system.

### BRIEF DESCRIPTION OF THE FIGURE

FIG. 1 shows a contemplated layered material.

### DETAILED DESCRIPTION

A suitable interface material, layer or component should conform to the mating surfaces (“wets” the surface), possess a low bulk thermal resistance and possess a low contact resistance. Bulk thermal resistance can be expressed as a function of the material's or component's thickness, thermal conductivity and area. Contact resistance is a measure of how well a material or component is able to make contact with a mating surface, layer or substrate. The thermal resistance of an interface material, layer or component can be shown as follows:

Θ interface=t/kA+2Θ_{contact} Equation 1
where Θ is the thermal resistance,
t is the material thickness,
k is the thermal conductivity of the material
A is the area of the interface

The term “t/kA” represents the thermal resistance of the bulk material and “2Θ_{contact}” represents the thermal contact resistance at the two surfaces. A suitable interface material or component should have a low bulk resistance and a low contact resistance, i.e. at the mating surface.

Many electronic and semiconductor applications require that the interface material or component accommodate deviations from surface flatness resulting from manufacturing and/or warpage of components because of coefficient of thermal expansion (CTE) mismatches.

A material with a low value for k, such as thermal grease, performs well if the interface is thin, i.e. the “t” value is low. If the interface thickness increases by as little as 0.002 inches, the thermal performance can drop dramatically. Also, for such applications, differences in CTE between the mating components causes the gap to expand and contract with each temperature or power cycle. This variation of the interface thickness can cause pumping of fluid interface materials (such as grease) away from the interface.

Interfaces with a larger area are more prone to deviations from surface planarity as manufactured. To optimize thermal performance, the interface material and/or interface layer should be able to conform to non-planar surfaces and thereby lower contact resistance. As used herein, the term “interface” means a couple or bond that forms the common boundary between two parts of matter or space, such as between two molecules, two backbones, a backbone and a network, two networks, etc. An interface may comprise a physical attachment of two parts of matter or components or a physical attraction between two parts of matter or components, including bond forces such as covalent and ionic bonding, and non-bond forces such as Van der Waals, electrostatic, coulombic, hydrogen bonding and/or magnetic attraction. Contemplated interfaces include those interfaces that are formed with bond forces, such as covalent bonds; however, it should be understood that any suitable adhesive attraction or attachment between the two parts of matter or components is preferred.

Optimal interface materials and interconnect materials and/or components possess a high thermal conductivity and a high mechanical compliance, e.g. will yield elastically when force is applied. High thermal conductivity reduces the first term of Equation 1 while high mechanical compliance reduces the second term. The layered interface materials and the individual components of the layered interface materials described herein accomplish these goals. When properly produced, the heat spreader component described herein will span the distance between the mating surfaces of the thermal interface material and the heat spreader component, thereby allowing a continuous high conductivity path from one surface to the other surface.

One problem with conventional flip chip technologies has been solved by replacing the gold layer between the spreader and the indium solder with a thin layer of indium. These indium layers are generally applied utilizing a plating process, such as the process described in U.S. Pat. No. 7,378,730 and U.S. patent application Ser. No. 11/961,067 both owned by Honeywell International Inc. and incorporated herein by reference in their entirety. Replacing the gold layer with a thin, plated indium layer results in enhanced bonding between the indium solder and the heat spreader surface and excellent thermal performance of the finished component. Based on these results, it is expected that replacing the gold layers applied between the silicon surface and the indium solder layer with an indium layer would be advantageous, even though the titanium layer will still be required in a new design.

A layered thermal interface system is described herein that comprises: at least one deposition layer of metal, at least one layer of thermal interface material, at least one plated layer of metal, and at least one heat spreader. Another layered thermal interface system is described herein that comprises: a silicon layer, at least one deposition layer of metal, at least one layer of thermal interface material, at least one plated layer of metal, and at least one heat spreader.

In these embodiments, it is contemplated that at least one of the metal layers is: a) applied utilizing a deposition process, and b) thin, very thin or ultra-thin, and this layer is referred to as “a deposition layer of metal” or “at least one deposition layer of metal”. In some embodiments, it is contemplated that at least one of the metal layers is: a) applied utilizing a plating process, and b) thin, very thin or ultra-thin, and this layer is referred to as “a plated layer of metal” or “at least one plated layer of metal”. It is contemplated that the layer of thermal interface material is sandwiched by the layers of metal.

As used herein, the term “metal” means those elements that are in the d-block and f-block of the Periodic Chart of the Elements, along with those elements that have metal-like properties, such as silicon and germanium. The term “metal” includes the group of metals commonly referred to as transition metals. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. Contemplated metals include indium, lead, gold, silver, copper, tin, bismuth, gallium and alloys thereof, silver coated copper, and silver coated aluminum. The term “metal” also includes alloys, metal/metal composites, metal ceramic composites, metal polymer composites, as well as other metal composites.

The relationship between the at least one layer of thermal interface material and the at least one layer of metal is important, because it is not contemplated that additional wetting layers or materials are necessary. They may be used in some instances, but they are not required, as with conventional systems. To that end, the at least one layer of thermal interface material and the at least one layer of metal should be complimentary to one another, in that voiding is minimized and the reliability of the thermal joint or thermal package is improved over a conventional thermal package.

In some embodiments, the at least one layer of thermal interface material, the at least one deposition layer of metal and the at least one plated layer of metal comprise a similar, complementary, compatible or a common material, such as indium. It may be contemplated that for a blended or composite thermal interface material that the deposition layer of metal and the plated layer of metal may be different from one another and yet both complementary to the thermal interface material For example, the thermal interface material may comprise a layer of solder alloy. The deposition layer of metal may comprise the same material as one of the materials in the solder alloy and the plated layer of metal may comprise the same material as the other material in the solder alloy depending on the needs of the component or the customer.

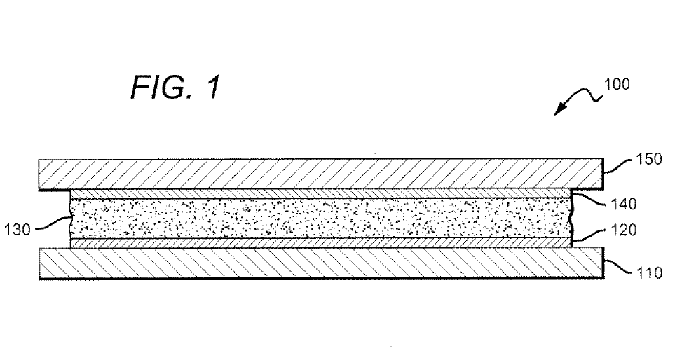

In some embodiments, a layered material comprises: a silicon surface or layer 110, a deposition layer of indium metal 120 coupled to the silicon surface 110, a layer of thermal interface material, such as indium solder material 130 coupled to the deposition layer of indium metal 120, a plated layer of indium metal 140 coupled to a top side of the layer of indium solder 130 and a heat spreader material 150 coupled to a bottom side of the plated layer of indium metal. FIG. 1 shows a contemplated embodiment 100 as described herein. It should be understood from the description provided herein that there may be embodiments of the layered material that do not initially comprise the silicon surface or layer 110 and/or the heat spreader material 150.

The deposition layer of indium and the plated layer of indium are both compatible with the indium solder material. In some embodiments, the at least one deposition layer of metal and the at least one thermal interface material share a common interface. Contemplated common interfaces comprises a strength component. In this particular embodiment where indium is utilized, the strength or strength component at the interface between the at least one deposition layer of metal and the at least one thermal interface material can be measured and quantified in terms of a modulus of elasticity or Young's modulus. For this embodiment, a range of the strength component has been found to be less than 12 GPa, and in some embodiments, between about 10 and 12 GPa.

Each of the metal layers, including the at least one deposition layer of metal and the at least one plated layer of metal described herein should first be able to be laid down in a thin or ultra thin continuous layer or pattern. The pattern may be produced by the use of a mask or the pattern may be produced by a device capable of laying down a desired pattern. Contemplated patterns include any arrangement of points or dots, whether isolated or combined to form lines, filled-in spaces and so forth. Thus, contemplated patterns include straight and curved lines, intersections of lines, lines with widened or narrowed areas, ribbons, overlapping lines. Contemplated thin layers and ultra thin layers may range from less than about 1 μm down to about one Angstrom or even down to the size of a single atomic layer of material. Specifically, some contemplated thin layers are less than about 1 μm thick. In other embodiments, contemplated thin layers are less than about 500 nm thick. In some embodiments, contemplated ultra thin layers are less than about 100 nm thick. In yet other embodiments, contemplated ultra thin layers are less than about 10 nm thick.

The deposition layer of metal may be laid down or applied to a surface, such as silicon, utilizing any suitable deposition method. Although this indium layer can be applied by any suitable method, in some contemplated embodiments, the layer is applied utilizing an evaporative technique, vapor deposition, physical vapor deposition, chemical vapor deposition or another similar technique. In some embodiments, the deposition layer of metal, such as indium, may be deposited by utilizing physical vapor deposition with a target that comprises the deposition layer metal.

The plated layer of metal, as mentioned earlier, may be laid down by any suitable plating method, including the plating methods owned by Honeywell International Inc. These layers are generally laid down by any method capable of producing a uniform layer with a minimum of pores or voids and can further lay down the layer with a relatively high deposition rate. Many suitable methods and apparatus are available to lay down layers or ultra thin layers of this type, however, one of the best apparatus and methods of achieving a high quality layer of material is pulsed plating. Pulsed plating (which is intermittent plating as opposed to direct current plating) can lay down layers that are free or virtually free of pores and/or voids. It has been discovered that the lack of pores helps to control migration of the constituents of the other layers past the plated layer. For example, when a gold layer is pulse plated onto a nickel-based heat spreader, the relatively nonporous gold layer effectively controls migration of nickel atoms across the gold layer and into adjacent layers. On the contrary, direct current plating, which is suitable for many applications, including decorative jewelry, connections and other applications where thicker (greater than about 1 μm), cannot provide the essentially pore free layers that are required for the applications described herein.

Another method of laying down thin layers or ultra thin layers is the pulse periodic reverse method or “PPR”. The pulse periodic reverse method goes one step beyond the pulse plating method by actually “reversing” or depleting the film at the cathode surface. A typical cycle for pulse periodic reverse might be 10 ms at 5 amps cathodic followed by 0.5 ms at 10 amps anodic followed by a 2 ms off time. There are several advantages of PPR. First, by “stripping” or deplating a small amount of film during each cycle, PPR forces new nucleation sites for each successive cycle resulting in further reductions in porosity. Second, cycles can be tailored to provide very uniform films by selectively stripping the thick film areas during the “deplating” or anodic portion of the cycle. PPR does not work well for some metal deposition, such as gold deposition, because gold plating is normally done in systems with no free cyanide. Hence gold will plate from a cyanide complex (chelate) during the plate cycle but cannot “strip” during the deplate cycle as there is no cyanide to allow the gold to re-dissolve. Pulse plating and pulse periodic reverse systems can be purchased from any suitable source, such as a company like Dynatronix™ or built (in whole or in part) on site.

The at least one thermal interface material may comprise any suitable thermal interface material, such as a polymer solder, a phase change material, a solder material, materials that comprise high conductivity fillers and/or matrix materials, or a combination thereof. Some suitable thermal interface materials are those found in U.S. application Ser. No. 11/493,788, which is commonly-owned by Honeywell International Inc. and incorporated herein in its entirety. Some additional thermal interface materials are those found in U.S. Pat. Nos. 6,238,596, 6,811,725B2, 6,605,238, 6,451,422, 6,908,669, 7,244,491, 6,673,434, 6,797,382 and 7,172,711, which are commonly-owned by Honeywell International Inc. and incorporated herein in their entirety.

A contemplated thermal interface material may comprise any suitable solder material, as long as the material forms a desirable interface with the various layers of metals described earlier. Some contemplated solder materials are indium, indium tin (InSn) alloys, indium silver (InAg) alloys, indium-bismuth (InBi) alloys, tin indium bismuth (SnInBi), indium tin silver zinc (InSnAgZn), indium-based alloys, tin silver copper alloys (SnAgCu), tin bismuth and alloys (SnBi), and gallium-based compounds and alloys. Contemplated solder materials are those materials that comprise indium. The solder may or may not be doped with additional elements to promote wetting to the heat spreader or die backside surfaces.

Metal and metal-based materials also manufactured by Honeywell International Inc., such as Ni, Cu, Al and AlSiC, which are classified as heat spreaders, i.e., materials that work to dissipate heat. Thermal interconnect materials and layers may also comprise metals, metal alloys and suitable composite materials that meet the following design goals: a) can be laid down in a thin or ultra thin layer or pattern; b) can conduct thermal energy better than conventional thermal adhesives; c) has a relatively high deposition rate; d) can be deposited on a surface or other layer without having pores develop in the deposited layer; e) can control migration of the underlying layer of material; and f) can be laid down as a coating in order to keep the surface free of oxides and ready to accept solder. These thermal interface materials, thermal interconnect materials, components and products comprising these materials may advantageously be pre-attached/pre-assembled thermal solutions and/or IC (interconnect) packages.

A method of forming a contemplated layered thermal system comprises: a) providing at least one deposition layer of metal, b) providing at least one plated layer of metal, c) providing at least one thermal interface material, and d) layering the at least one deposition layer of metal, the at least one thermal interface material, and the at least one plated layer of metal to produce the layered thermal system.

Another method of forming contemplated layered thermal system comprises: a) providing a silicon die, layer or surface, b) providing at least one deposition layer of metal, c) providing at least one plated layer of metal, d) providing at least one thermal interface material, e) providing at least one heat spreader material, and f) layering the silicon surface, the at least one deposition layer of metal, the at least one thermal interface material, the at least one plated layer of metal and the at least one heat spreader material to produce the layered thermal system.

Once the thermal interconnect layer is deposited it is understood that it will have a relatively high thermal conductivity as compared to conventional thermal adhesives and other thermal layers. Additional layers, such as a metalized silicon die can be soldered directly to the thermal interconnect layer without the use of such damaging materials as corrosive fluxes that may be needed to remove oxides of the materials, such as nickel, used to produce the thermal spreader.

The layered interface material and/or interconnect material may then be applied to a substrate, another surface, or another layered material. Substrates contemplated herein may comprise any desirable substantially solid material. Particularly desirable substrate layers would comprise films, glass, ceramic, plastic, metal or coated metal, or composite material. In preferred embodiments, the substrate comprises a silicon or germanium arsenide die or wafer surface, a packaging surface such as found in a copper, silver, nickel or gold plated leadframe, a copper surface such as found in a circuit board or package interconnect trace, a via-wall or stiffener interface (“copper” includes considerations of bare copper and it's oxides), a polymer-based packaging or board interface such as found in a polyimide-based flex package, lead or other metal alloy solder ball surface, glass and polymers such as polyimide. The “substrate” may even be defined as another polymer material when considering cohesive interfaces. In more preferred embodiments, the substrate comprises a material common in the packaging and circuit board industries such as silicon, copper, glass, and another polymer.

Additional layers of material may be coupled to the layered interface materials in order to continue building a layered component. It is contemplated that the additional layers will comprise materials similar to those already described herein, including metals, metal alloys, composite materials, polymers, monomers, organic compounds, inorganic compounds, organometallic compounds, resins, adhesives and optical wave-guide materials.

A layer of laminating material or cladding material can be coupled to the layered interface materials depending on the specifications required by the component. Laminates are generally considered fiber-reinforced resin dielectric materials. Cladding materials are a subset of laminates that are produced when metals and other materials, such as copper, are incorporated into the laminates. (Harper, Charles A., Electronic Packaging and Interconnection Handbook, Second Edition, McGraw-Hill (New York), 1997.)

Applications of the contemplated thermal solutions, IC Packages, thermal interface components, layered interface materials and heat spreader components described herein comprise incorporating the materials and/or components into another layered material, an electronic component or a finished electronic product. Electronic components, as contemplated herein, are generally thought to comprise any layered component that can be utilized in an electronic-based product. Contemplated electronic components comprise circuit boards, chip packaging, separator sheets, dielectric components of circuit boards, printed-wiring boards, and other components of circuit boards, such as capacitors, inductors, and resistors.

Electronic-based products can be “finished” in the sense that they are ready to be used in industry or by other consumers. Examples of finished consumer products are a television, a computer, a cell phone, a pager, a palm-type organizer, a portable radio, a car stereo, and a remote control. Also contemplated are “intermediate” products such as circuit boards, chip packaging, and keyboards that are potentially utilized in finished products.

Electronic products may also comprise a prototype component, at any stage of development from conceptual model to final scale-up/mock-up. A prototype may or may not contain all of the actual components intended in a finished product, and a prototype may have some components that are constructed out of composite material in order to negate their initial effects on other components while being initially tested.

Thus, specific embodiments and applications of thermal solutions, IC packaging, thermal interconnect and interface materials have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. A layered thermal interface system, comprising:
a silicon layer,
at least one deposition layer of metal,
at least one layer of thermal interface material,
at least one plated layer of metal, and
at least one heat spreader material.

2. The layered thermal interface system of claim 1, wherein the silicon layer comprises a silicon die, a silicon-based surface or a silicon chip.

3. The layered thermal interface system of claim 1, wherein the at least one deposition layer of metal comprises indium.

4. The layered thermal interface system of claim 1 wherein the at least one deposition layer of metal is thin.

5. The layered thermal interface system of claim 1, wherein the at least one deposition layer of metal is ultra-thin.

6. The layered thermal interface system of claim 1, wherein the at least one plated layer of metal comprises indium.

7. The layered thermal interface system of claim 1, wherein the at least one plated layer of metal is thin.

8. The layered thermal interface system of claim 1, wherein the at least one plated layer of metal is ultra-thin.

9. The layered thermal interface system of claim 1, wherein the at least one thermal interface material comprises a solder or solder alloy.

10. The layered thermal interface system of claim 9, wherein the solder or solder alloy comprise indium.

11. The layered thermal interface system of claim 1, wherein the at least one deposition layer of metal and the at least one thermal interface material share a common interface.

12. The layered thermal interface system of claim 11, wherein the common interface comprises a strength component.

13. The layered thermal interface system of claim 12, wherein the strength component is less than about 12 GPa.

14. The layered thermal interface system of claim 12, wherein the strength component is in a range of between 10 and 12 GPa.

15. A layered thermal interface system, comprising:
a silicon layer,
at least one deposition layer of metal,
at least one layer of thermal interface material,
at least one plated layer of metal, wherein the at least one deposition layer of metal, the at least one layer of thermal interface material or a combination thereof is compatible with the at least one layer of thermal interface material; and
at least one heat spreader material.

16. The layered thermal interface system of claim 15, wherein the at least one deposition layer of metal, the at least one layer of thermal interface material or a combination thereof comprises a constituent of the at least one layer of thermal interface material.

17. A method of forming contemplated layered thermal system, comprising:
providing at least one deposition layer of metal,
providing at least one plated layer of metal,
providing at least one thermal interface material, and
layering the at least one deposition layer of metal, the at least one thermal interface material, and the at least one plated layer of metal to produce the layered thermal system

18. The method of claim 17, further comprising:
providing a silicon die, layer or surface,
providing at least one heat spreader material, and
layering the silicon surface, the at least one deposition layer of metal, the at least one thermal interface material, the at least one plated layer of metal and the at least one heat spreader to produce the layered thermal system.

19. The method of claim 17, wherein the at least one deposition layer of metal, the at least one plated layer of metal, or a combination thereof comprises indium.

20. The method of claim 17, wherein the at least one thermal interface material comprises indium.
